(19) United States
(12) Patent Application Publication
(10) Pub. No.: US 2014/0356224 A1
(43) Pub. Date: Dec. 4, 2014

(54) COPPER ALLOY

(71) Applicant: Kabushiki Kaisha Kobe Seiko Sho (Kobe Steel, Ltd.), Kobe-shi, Hyogo (JP)

(72) Inventors: Hisao Shishido, Kobe-shi (JP); Yuki Tanaka, Kobe-shi (JP); Yuya Sumino, Shimonoseki-shi (JP); Akira Fugono, Shimonoseki-shi (JP)

(73) Assignee: Kabushiki Kaisha Kobe Seiko Sho (Kobe Steel, Ltd.), Kobe-shi, Hyogo (JP)

(21) Appl. No.: 14/370,096

(22) PCT Filed: Feb. 21, 2013
(86) PCT No.: PCT/JP13/54293

§ 371 Date: Jul. 1, 2014

(30) Foreign Application Priority Data
Feb. 24, 2012 (JP) 2012-039365
Mar. 27, 2012 (JP) 2012-071741

(51) Int. Cl. H01B 1/02; C22C 9/00

(52) U.S. Cl. CPC H01B 1/026; C22C 9/00
USPC 420/473; 420/490; 420/485; 420/487; 420/477; 420/470; 420/489

(57) ABSTRACT

Provided is a copper alloy sheet excellent in strengths, electroconductivity, and bending workability. The copper alloy contains Cr of 0.10% to 0.50%, Ti of 0.010% to 0.30%, and Si of 0.01% to 0.10%, where a ratio (in mass) of the Cr content to the Ti content is from 1.0 to 30, a ratio (in mass) of the Cr content to the Si content is from 3.0 to 30, with the remainder including copper and inevitable impurities. The copper alloy includes grains that have an average major axis length of 6.0 μm or less and an average minor axis length of 1.0 μm or less as measured on a microstructure of the copper alloy in a plane surface perpendicular to a transverse direction by FESEM-EBSP analysis.

### TECHNICAL FIELD

The present invention relates to copper alloys having high strengths and satisfactory electroconductivity and further having excellent bending workability. Specifically, the present invention relates to copper alloys that are suitable as materials for electric/electronic components for use typically in connectors, lead frames, relays, switches, wiring or interconnections, and terminals forming electric/electronic components.

### BACKGROUND ART

With recent demands for reduction in size and weight of electronic equipment, electrical systems in electric/electronic components have become more and more complicated and integrated. Electric/electronic component materials for use in these applications require such a property as to be compatible with reduction in wall thickness and working into a complicated shape.

For example, an electric/electronic component material to be used typically in connectors, lead frames, relays, and switches to form an electric/electronic component, when undergoing reduction in size and wall thickness of the electric/electronic component, has a smaller cross-sectional area to receive an identical load and has a smaller cross-sectional area through which an electric current at an identical level passes. The material therefore requires satisfactory electroconductivity to suppress the generation of Joule heat upon the passage of electric current; such a high strength as to endure stress applied upon assembly or activation of the electric/electronic equipment; and such bending workability as to resist rupture or another defect even when the electric/electronic component is bent.

Cu—Fe—P alloys are widely used as electric/electronic component materials. However, the Cu—Fe—P alloys, when incorporated with an alloy element such as Sn so as to have higher strengths, have inferior electroconductivity and difficultly offer good balance between strengths and electroconductivity (strengths-electroconductivity balance).

Independently, precipitation-hardening alloys (Cu—Ni—Si alloys) have been proposed as high-strength materials. However, the alloys, when having a lower content of Ni and/or Si, have an inferior tensile strength and difficultly offer good strengths-electroconductivity balance.

Patent literature (PTL) 1 proposes a Cu—Cr alloy superior in strengths-electroconductivity balance to the customary Cu—Fe—P alloys and Cu—Ni—Si alloys.

PTL 2 proposes a Cu—Cr—Sn alloy as a copper alloy superior in strengths-electroconductivity balance and workability.

PTL 3 proposes a Cu—Cr—Ti—Zr alloy as a copper alloy superior in strengths and electroconductivity.

PTL 4 proposes a Cu—Cr—Ti—Si alloy as a copper alloy having high strengths and satisfactory electroconductivity and offering better bending workability.

### CITATION LIST

### Patent Literature

PTL 1: Japanese Unexamined Patent Application Publication (JP-A) No. 2005-29857

PTL 2: JP-A No. H06-081090

PTL 3: Japanese Patent No. 3731600

PTL 4: Japanese Patent No. 2515127

### SUMMARY OF INVENTION

### Technical Problem

The Cu—Cr alloy suffers from the formation of coarse crystallized grains upon hot rolling and has limitations on improvements both in strength and electroconductivity.

The Cu—Cr—Sn alloy is disadvantageous in manufacturing because typically of requiring a solution treatment at a high temperature and requiring complicated manufacturing processes.

The Cu—Cr—Ti—Zr alloy is insufficient in bending workability, although offering higher strengths and better electroconductivity.

The Cu—Cr—Ti—Si alloy disadvantageously suffers typically from cracking upon the application of bending under conditions more severe than ever, as mentioned later, although having better bending workability.

With recent reduction in weight and size of electric/electronic equipment, electric/electronic component materials undergo working still more complicated than ever. Typically, such materials may be subjected to further reduction in wall thickness or fine-pitch notching for the formation of interconnections prior to bending. The materials therefore require not only higher strengths but also still better bending workability. Demands are therefore made to provide materials that are satisfactory in respective properties of electroconductivity, strengths, and bending workability, and still offer electroconductivity and bending workability both at higher levels even at high strengths of predetermined levels or higher. Specifically, demands are made to provide materials excellent not only in strengths-electroconductivity balance but also particularly in strengths-bending workability balance.

The present invention has been made under these circumstances, and an object thereof is to provide a copper alloy that offers excellent balance among strengths, electroconductivity, and bending workability. The term “strengths” hereinafter refers to tensile strength and 0.2% yield strength.

### Solution to Problem

The present invention has achieved the object and provides a copper alloy containing Cr in a content of from 0.10% to 0.50%; Ti in a content of from 0.010% to 0.30%; and Si in a content of from 0.01% to 0.10%, in mass percent, in which a ratio (in mass) of the Cr content to the Ti content is from 1.0 to 30; a ratio (in mass) of the Cr content to the Si content is from 3.0 to 30; the copper alloy further comprises copper and inevitable impurities; the copper alloy comprises grains having an average major axis length of 6.0 or less and an average minor axis length of 1.0 μm or less as measured on a microstructure of the copper alloy in a plane surface perpendicular to a transverse direction by field emission scanning electron microscopy-electron backscatter diffraction pattern (FESEM-EBSP) analysis.

In a preferred embodiment, the grains in the copper alloy may have an average major axis length of 5.0 m or less and an average minor axis length of 0.40 μm or less; and the grains may have an average aspect ratio of from 0.115 to 0.300 where the aspect ratio of a grain is defined as a ratio of a minor axis to a major axis of the grain.

In preferred embodiments of the present invention, the copper alloy may further contain: at least one element selected from the group consisting of Fe, Ni, and Co in a total content of 0.3% or less; may contain Zn in a content of 0.5% or less; and/or may contain at least one element selected from the group consisting of Sn, Mg, Al in a total content of 0.3% or less.

### Advantageous Effects of Invention

The copper alloy according to the embodiment of the present invention has high strengths in terms of tensile strength of 470 MPa or more and 0.2% yield strength of 450 MPa or more, satisfactory electroconductivity in terms of electric conductivity of 70% IACS (International Annealed Copper Standard) or more, and excellent bending workability better than Level D, where the bending workability is determined upon W-bending at a ratio of bend radius R to thickness t of 0.5 or 1.0 and is rated in nine levels as indicated in experimental examples mentioned later, where the nine-level criteria are in accordance with the criteria for maximum width (μm) of “wrinkles” or “cracks” as prescribed in Japan Copper and Brass Association Technical Standard JBMA-T307: 2007. The copper alloy according to the embodiment of the present invention therefore has good balance between strengths and electroconductivity, has high strengths, and still resists cracking even when subjected to bending under severe conditions. The copper alloy according to the embodiment of the present invention is suitable as a material for an electric/electronic component and particularly suitable as a material for an electric/electronic component having a thickness (t) of from about 0.1 to about 1.0 mm.

### BRIEF DESCRIPTION OF DRAWINGS

FIG. 1 is a schematic explanatory drawing illustrating a location where a microstructure of the copper alloy according to the embodiment of the present invention is determined by FESEM-EBSP analysis, where the location is a plane surface of the copper alloy perpendicular to the transverse direction.

### DESCRIPTION OF EMBODIMENTS

The present inventors made intensive investigations on conditions to provide satisfactory balance between strengths and electroconductivity; and preferably to resist cracking even under severe working conditions as in W-bending while maintaining high strengths, namely, to offer better bending workability (preferably better balance between strengths and bending workability). As a result, the present inventors have found that a Cr—Ti—Si copper alloy can have better bending workability (preferably better balance between strengths and bending workability) while maintaining strengths-electroconductivity balance at satisfactory level by controlling the chemical composition (elements), allowing at least part of the elements to precipitate, controlling sizes of the precipitated grains, and preferably further controlling shapes of the grains. The present invention has been made based on these findings.

Refined grains most feature the copper alloy according to the embodiment of the present invention, and this will initially be described in detail.

In general, a copper alloy is known to have better bending workability with a decreasing average grain size. The knowledge, however, relates to recrystallized grains that are formed by subjecting the copper alloy to a heat treatment at a high temperature in consideration of bending workability alone. In contrast, the present inventors made investigations starting from copper alloy manufacturing conditions and made intensive investigations on a copper alloy that can maintain satisfactory strengths-electroconductivity balance and still offers better bending workability (preferably better balance between strengths and bending workability). As a result, they found that a specific copper alloy undergoing insufficient recrystallization is effective for achieving the object, where the copper alloy is manufactured at a low annealing temperature so as to suppress recrystallization. However, the copper alloy had too small microstructures (grains) typically for optical microscopic observation to suitably evaluate the relation between the grains and the copper alloy properties. This required further investigations on how copper alloy properties such as workability vary depending on the specific shapes and sizes of grains.

The present inventors made investigations in detail on copper alloy grains using FESEM-EBSP analysis. As a result, they have found that the copper alloy can maintain strengths, electroconductivity, and bending workability in good balance by suitably controlling average major axis (largest dimension) length and average minor axis (smallest dimension) length of the grains; and that, in a preferred embodiment, the copper alloy can have still better balance between strengths and bending workability upon bending by controlling the grains not only on the average major axis length and average minor axis length, but also on the aspect ratio, because this optimizes grain boundary spacing and thereby facilitates grain boundary sliding.

As is described above, the copper alloy can maintain strengths, electroconductivity, and bending workability in good balance even when subjected to bending under more severe conditions than ever by controlling not only the major axes and minor axes of grains but also, preferably, grain aspect ratio.

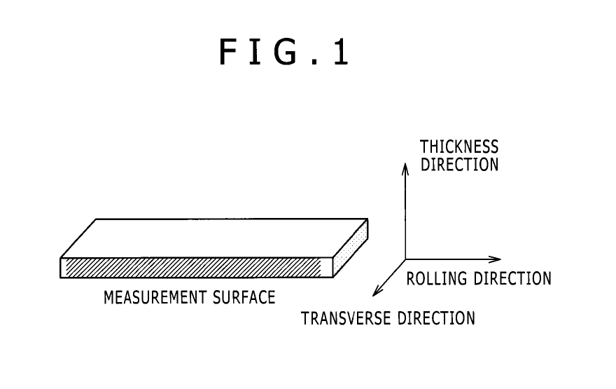

The copper alloy according to the embodiment of the present invention includes grains that have an average major axis length of 6.0 μm or less and an average minor axis length of 1.0 μm or less, where the major axes and minor axes of the grains are measured on a microstructure of the copper alloy in a plane surface perpendicular to the transverse direction (see FIG. 1) by FESEM-EBSP analysis.

A copper alloy having an average major axis length of grains of more than 6.0 μm may have inferior bending workability due to longer grain boundary spacing in the major axis direction. To prevent this, the copper alloy may have an average major axis length of grains of 6.0 μm or less, preferably 5.0 μm or less, and more preferably 3.8 μm or less. The average major axis length is not critical in lower limit.

A copper alloy having an average minor axis length of grains of more than 1.0 μm may have insufficient bending workability because of longer grain boundary spacing in the minor axis direction and may have lower strengths. To prevent this, the copper alloy may have an average minor axis length of grains of 1.0 μm or less, preferably 0.5 μm or less, more preferably 0.40 μm or less, and furthermore preferably 0.32 μm or less. The average minor axis length is not critical in lower limit.

The grains of the copper alloy according to the embodiment of the present invention have sizes within the ranges and are not critical on their shapes. In a preferred embodiment, the copper alloy can have still better strengths-bending workability balance by controlling the average major axis length and average minor axis length within the ranges and further controlling the average aspect ratio of grains of preferably from 0.115 to 0.300, where the aspect ratio is defined as a ratio of the minor axis to the major axis. The copper alloy, if having an average aspect ratio of less than 0.115 even though having average major axis length and average minor axis length of grains within the ranges, may include grains with elongated shapes, have relatively longer grain boundary spacing in the major axis direction, have inferior balance in grain boundary spacing between the major axis direction and the minor axis direction, and fail to offer sufficient strengths-bending workability balance. In contrast, the copper alloy, if having an average aspect ratio of grains of more than 0.300, may undergo partial recrystallization and fail to offer sufficient strengths-bending workability balance. To prevent these, the copper alloy may have an average aspect ratio of grains of preferably 0.115 or more and more preferably 0.120 or more; and preferably 0.300 or less and more preferably 0.250 or less.

Of the grains, the average major axis length and average minor axis length, and average aspect ratio may be measured/calculated by FESEM-EBSP analysis. Specifically, these parameters may be measured by crystal orientation diffraction pattern analysis using a field emission scanning electron microscope (FESEM) equipped with an electron backscatter diffraction pattern (EBSP) analysis system. In the EBSP analysis, a sample is set in a lens-barrel of the FESEM, electron beams are applied to the sample, and an electron backscatter diffraction pattern is projected on a screen. An image of this is taken by a highly sensitive camera and captured into a computer. Based on image analysis by the computer, a largest dimension (major axis length) and a smallest dimension (minor axis length) of each grain are measured; and an average major axis length and an average minor axis length of all grains in the imaging field of view are calculated. An average aspect ratio is determined by calculating aspect ratio of individual grains as a ratio of the minor axis length to the major axis length; and averaging the aspect ratios of grains in the field of view.

The measurement herein is performed on a microstructure of the copper alloy in a surface of a plane perpendicular to the transverse direction by FESEM-EBSP analysis. In the measurement, the measurement field of view (measurement position and measurement size) is set as an area of 10 μm in thickness direction by 30 μm in rolling direction in the vicinity of thickness center of the measurement plane. The measurement is performed at arbitrary five points at measurement step intervals of 0.05 μm, and an average of measured values is calculated.

Next, the chemical composition of the copper alloy according to the embodiment of the present invention will be described blow. It is also important to control the chemical composition of the copper alloy according to the embodiment of the present invention so as to offer the desired advantageous effects.

Cr 0.10% to 0.50%

Chromium (Cr) precipitates as elemental metal chromium or a compound with Si and thereby advantageously contributes to higher strengths of the copper alloy. A copper alloy having a Cr content of less than 0.10% may difficultly ensure strengths at desired levels. Such copper alloy having an excessively low Cr content may have inferior electroconductivity because Ti precipitates in a smaller amount and is present as solute titanium in a larger amount. In contrast, a copper alloy having a Cr content of more than 0.50% may have inferior bending workability because coarse crystallized grains were formed in large amounts. To prevent these, the copper alloy may have a Cr content of 0.10% or more, preferably 0.2% or more; and 0.50% or less, preferably 0.40% or less.

Ti: 0.010% to 0.30%

Titanium (Ti) precipitates as a compound with Si and thereby advantageously contributes to higher strengths of the copper alloy. Titanium also advantageously lowers solid solubility limits of Cr and Si and accelerates precipitation of these elements. A copper alloy having a Ti content of less than 0.010% may difficultly ensure strengths at desired levels because Ti failed to form the precipitate in a sufficient amount. In contrast, a copper alloy having a Ti content of more than 0.30% may suffer from inferior bending workability because coarse crystallized grains were formed in large amounts. To prevent these, the copper alloy may have a Ti content of 0.010% or more, preferably 0.02% or more; and 0.30% or less, preferably 0.15% or less.

Si: 0.01% to 0.10%

Silicon (Si) precipitates as the compounds with Cr and Ti, respectively, and thereby advantageously contributes to higher strengths of the copper alloy. A copper alloy having a Si content of less than 0.01% may difficultly ensure strengths at desired levels because of insufficient formation of the precipitates. In contrast, a copper alloy having a Si content of more than 0.10% may have inferior electroconductivity or may suffer from inferior strengths-bending workability balance and/or bending workability because coarse crystallized grains were formed in large amounts. To prevent these, the copper alloy may have a Si content of 0.01% or more, preferably 0.02% or more; and 0.10% or less, preferably 0.08% or less.

For still better balance among strengths, electroconductivity, and bending workability, ratios of the contents of added elements (Cr, Ti, and Si) are herein controlled within ranges as follows.

Mass ratio of Cr to Ti (Cr/Ti): 1.0 to 30

The balance between Cr and Ti as the mass ratio (Cr/Ti) of Cr to Ti contained in the copper alloy affects strengths and electroconductivity. Specifically, higher strengths may be obtained with a decreasing ratio Cr/Ti. For this reason, the copper alloy desirably has a ratio Cr/Ti controlled to 30 or less, and preferably 15 or less. A copper alloy having a ratio Cr/Ti of less than 1.0 may contain solute titanium in an excessively large amount after temper aging, may have inferior electroconductivity, and may have impaired bending workability. To prevent this, the copper alloy desirably has a ratio Cr/Pi controlled to 1.0 or more, and preferably 3.0 or more.

Mass ratio of Cr to Si (Cr/Si): 3.0 to 30

The balance between Cr and Si as the mass ratio (Cr/Si) of Cr to Si affects bending workability and electroconductivity. Specifically, a copper alloy having an excessively high ratio Cr/Si may have inferior electroconductivity. To prevent this, the copper alloy desirably has a ratio Cr/Si controlled to 30 or less, and preferably 20 or less. In contrast, a copper alloy having a ratio Cr/Si of less than 3.0 may have inferior strengths-bending workability balance, and may have inferior electroconductivity because other elements are dissolved as solutes in larger amounts. To prevent this, the copper alloy desirably has a ratio Cr/Si controlled to 3.0 or more, and preferably 10 or more.

The present invention has a chemical composition and ratios Cr/Ti and Cr/Si meeting the above-specified conditions, with the remainder including copper and inevitable impurities. The inevitable impurities are typified by V, Nb, Mo, W, and other elements. The copper alloy, if containing inevitable impurities in excessively high contents, may suffer from deterioration typically in strengths, electroconductivity, and bending workability. To prevent this, the copper alloy desirably contains inevitable impurities in a total amount of preferably 0.1% or less, and more preferably 0.05% or less.

In embodiments, the copper alloy may further contain one or more of elements mentioned below.

At least one element selected from the group consisting of Fe, Ni, and Co in a total content of 0.3% or less (the content is a content of a single element when one of Fe, Ni, and Co is contained alone; and is a total content when two or more of the elements are contained in combination).

Iron (Fe), nickel (Ni), and cobalt (Co) precipitate as compounds with Si and advantageously help the copper alloy to have higher strengths and better electroconductivity. The copper alloy, if containing at least one of these elements in an excessively high content (total content), may suffer from impaired electroconductivity due to large amounts of solutes of the element(s). To prevent this, the copper alloy may contain the element(s) in a total content of preferably 0.3% or less, and more preferably 0.2% or less. In contrast, the copper alloy, if containing the element(s) in an excessively low content (total content), may fail to offer higher strengths and better electroconductivity effectively sufficiently. To prevent this, the copper alloy may contain the element(s) in a total content of preferably 0.01% or more, and more preferably 0.03% or more.

Zn: 0.5% or less

Zinc (Zn) advantageously helps a tin (Sn) coating or solder to have better thermal peeling resistance and to resist thermal peeling, where the tin coating or solder is for use in joining of an electrical component. To exhibit the advantage effectively, the copper alloy may contain Zn in a content of preferably 0.005% or more, and more preferably 0.01% or more. However, the copper alloy, if containing Zn in excess, may cause inferior wetting extendability of molten tin (Sn) or solder and may have inferior electroconductivity. To prevent this, the copper alloy may contain Zn in a content of preferably 0.5% or less.

At least one element selected from the group consisting of Sn, Mg, and Al in a total content of 0.3% or less (the content is a content of a single element when one of Sn, Mg, and Al is contained alone; and is a total content when two or more of the elements are contained in combination).

Tin (Sn), magnesium (Mg), and aluminum (Al) are dissolved as solutes and thereby effectively help the copper alloy to have higher strengths. To exhibit the advantage sufficiently, the copper alloy may contain at least one of the elements in a total content of preferably 0.01% or more, and more preferably 0.03% or more. In contrast, the copper alloy, if containing the element(s) in excess, may fail to offer desired properties because of inferior electroconductivity. To prevent this, the copper alloy may contain the element(s) in a total content of preferably 0.3% or less.

Next, preferred manufacturing conditions for the copper alloy according to the embodiment of the present invention will be illustrated below. In an embodiment (first manufacturing process) of the present invention, hot rolling and cold rolling are specifically performed respectively at high rolling reductions so as to allow grains to have major axes and minor axes controlled within the specific average ranges in length.

In another embodiment (second manufacturing process) of the present invention, cold rolling is performed multiple times, and process annealing is performed between one cold rolling and another so as to obtain grains having average major axis length and average minor axis length and having an average aspect ratio all falling within the specific ranges.

Specifically, the second manufacturing process may be employed in addition to the first manufacturing process in order to control the average aspect ratio in addition to the average lengths.

According to the first manufacturing process, a copper alloy (final sheet) is manufactured by preparing a material copper alloy having a regulated chemical composition; melting and casting the copper alloy to form an ingot; and subjecting the ingot sequentially to heating (including soaking), hot rolling, cold rolling, and temper aging. The resulting copper alloy according to the first embodiment of the present invention (hereinafter also simply referred to as “first copper alloy”) contains grains controlled in average major axis length and average minor axis length within the specific ranges.

According to the second manufacturing process, a copper alloy (final sheet) is manufactured by performing the processes of the first manufacturing process up to the hot rolling, and subsequently performing cold rolling multiple times and process annealing. The resulting copper alloy according to the second embodiment of the present invention (hereinafter also briefly referred to as “second copper alloy”) contains grains controlled not only in average major axis length and average minor axis length, but also in average aspect ratio within the specific ranges.

The melting and casting of material copper alloy, and subsequent heat treatment(s) herein may be performed according to common procedures. Typically, a material copper alloy having an adjusted predetermined chemical composition is melted in an electric furnace and subjected typically to continuous casting to give a copper alloy ingot. The ingot is then heated up to a temperature of from about 800° C. to 1000° C. Where necessary, soaking of holing the ingot for a predetermined time (e.g., form 10 to 120 minutes) may be performed.

According to the embodiment of the present invention, the hot rolling may be performed to a rolling reduction of preferably 70% or more. The hot rolling, if performed to a rolling reduction of less than 70%, may fail to control the average major axis length and average minor axis length of grains within the predetermined ranges even when the downstream cold rolling is performed to a high rolling reduction. The hot rolling may be more preferably performed to a rolling reduction of 90% or more. The upper limit of the hot rolling reduction is not critical and may be determined in consideration of a target thickness and the after-mentioned cold rolling reduction. The rolling reduction does not have to be achieved in one hot rolling. When performed multiple times, it is enough to perform hot rolling multiple times so as to give a total rolling reduction of 70% or more.

The work after hot rolling is desirably rapidly cooled down to room temperature. Cooling after hot rolling, if performed at an excessively low cooling rate, may cause grains after hot rolling to be large (to coarsen), and this may cause the final sheet to contain larger grains and to have inferior bending workability. To prevent this, the cooling after hot rolling is desirably performed at an average cooling rate higher than that in air cooling and is preferably performed at an average cooling rate of 50° C./s or more. The cooling rate is not critical in upper limit. The rapid cooling may be performed typically by water cooling.

According to the embodiment of the present invention, cold rolling to be performed after hot rolling and before temper aging may be performed to a cold rolling reduction of 90% or more. The cold rolling, when performed to a high cold rolling reduction, may allow elongated grains to be divided and may allow grains to have smaller grain sizes (to be refined) particularly in the major axis direction. The cold rolling, if performed to a cold rolling reduction of less than 90%, may cause insufficient strain and fail to cause dividing of grains. This may cause grains to be excessively large in the major axis direction and cause the copper alloy to offer inferior bending workability. The cold reduction is preferably performed to a cold rolling reduction of 93% or more. In contrast, the upper limit of the cold rolling reduction is not critical and may suitably be adapted so as to give a desired product thickness. In an embodiment of the present invention, cold rolling is performed once to a high rolling reduction, and no tempering-annealing is performed prior to the cold rolling, so as to give the desired grains. This is because grains may fail to have an average major axis length or average minor axis length controlled within the predetermined range if cold rolling is performed multiple times or if tempering-annealing is performed prior to cold rolling.

It is enough to perform cold rolling once so as to control the average lengths alone, but cold rolling may be performed multiple times. In an embodiment to further control the average aspect ratio, cold rolling is performed multiple times (in two or more passes) after the hot rolling, and process annealing is performed between one cold rolling and another. Cold rolling, when performed multiple times (in two or more passes), may allow grains to be refined. In this case, however, process annealing should be performed so as to allow the grains to have an average aspect ratio within the predetermined range. Repetition of cold rolling and process annealing may allow grains to be refined and to have minor axes and major axes controlled within the predetermined ranges. In addition, recovery phenomenon occurring during process annealing may allow the grains to have an aspect ratio controlled within the predetermined range.

Cold rolling, when performed multiple times, may be performed to a total cold rolling reduction of 95% or more so as to control the average aspect ratio. Such cold rolling may divide grains and refine the grains particularly in the major axis direction to have smaller grain sizes. The cold rolling, if performed to a total cold rolling reduction of less than 95%, may fail to introduce sufficient strain and to refine grains sufficiently. This may cause grains to be excessively large (coarse) in the major axis direction and to have relatively longer grain boundary spacing in the major axis direction. The grains may have inferior balance in grain boundary spacing between the major axis direction and the minor axis direction even after the process annealing to be described later and may fail to contribute to sufficient bending workability of the copper alloy. The cold rolling is preferably performed to a total cold rolling reduction of 97% or more. In contrast, the upper limit of the cold rolling reduction is not critical and may suitably be adapted so as to give a desired product thickness.

The manufacturing process according to the second embodiment of the present invention performs cold rolling multiple times. A cold rolling reduction per one pass is not critical. It is enough to perform cold rolling multiple times so as to give a total cold rolling reduction of 95% or more. The number of passes of cold rolling is also not critical. The cold reduction may be performed two or more times according to manufacturing conditions such as cold rolling facilities, so as to give a total cold rolling reduction of 95% or more.

The manufacturing process according to the second embodiment of the present invention performs process annealing between one cold rolling and another. When process annealing is performed after the cold rolling that refines grains, the recovery phenomenon occurs during the annealing and contributes to the control of grains' aspect ratio. The process annealing, if performed at an excessively low temperature, may fail to cause diffusion (migration) of atoms and fail to control the aspect ratio within the predetermined range. In contrast, the process annealing, if performed at an excessively high temperature, may cause partial recrystallization, may thereby cause the copper alloy to have remarkably low strengths. In addition, the process annealing may fail to control the sizes and shapes of grains within the predetermined ranges and may cause the copper alloy to have inferior strengths-bending workability balance. To prevent these, the process annealing may be performed at a temperature of preferably 300° C. or higher, more preferably 350° C. or higher; and of preferably 600° C. or lower, more preferably 550° C. or lower. The process annealing may be performed for a duration not critical, but typically from about 30 minutes to about 10 hours. After the process annealing, the work may be cooled by water cooling or natural cooling prior to another cold rolling.

Temper aging may be performed after the cold rolling in the manufacturing process according to the first embodiment of the present invention; or after the final cold rolling in the manufacturing process according to the second embodiment of the present invention. The temper aging, when performed suitably, may help the copper alloy to contain the predetermined fine grains surely and to have higher strengths, better electroconductivity, and better bending workability.

The temper aging may be performed at a temperature of from about 350° C. to about 650° C. for a duration of from about 30 minutes to about 10 hours. After the aging, the work is desirably cooled by water cooling or natural cooling.

The present application claims priority from Japanese Patent Application No. 2012-039365 filed on Feb. 24, 2012 and Japanese Patent Application No. 2012-071741 filed on Mar. 27, 2012. The entire contents of the above applications are incorporated herein by reference.

### EXAMPLES

The present invention will be illustrated in further detail with reference to several experimental examples below. It should be noted, however, that the examples are by no means intended to limit the scope of the invention; that various changes and modifications are possible therein without departing from the spirit and scope of the invention; and all such changes and modifications fall within the scope of the invention.

### Experimental Example 1

### First Copper Alloys

Material copper alloys were melted with coverage of charcoal in a kryptol furnace in the air, cast into a cast-iron book mold, and yielded ingots of 100 mm thick or 40 mm thick (Samples Nos. 18 and 29). The ingots had chemical compositions given in Table 1 with the remainder including copper and inevitable impurities. The ingots were faced on surface, heated, held for one hour after reaching 950° C., hot-rolled to a predetermined rolling reduction as given in “hot rolling reduction” in Table 2, and thereby yielded sheets of 15 mm thick (Sample No. 29) or 10 mm thick. The sheets were cooled with water from a temperature of 700° C. or higher at an average cooling rate of 100° C./s. For Sample No. 29, cooling was performed by air cooling at an average cooling rate of 0.5° C./s.

To perform cold rolling to different cold rolling reductions after hot rolling, some of the samples before cold rolling were cut by facing into sheets of 7 mm thick (Sample No. 22) or 4 mm thick (Samples Nos. 27 and 28). Sample No. 29 after hot rolling was faced from 15 mm thick to 10 mm thick.

The works were subjected to cold rolling (to a “cold rolling reduction” as given in Table 2) and yielded copper alloy sheets each having a thickness after final cold rolling of 0.64 mm. The copper alloy sheets were then subjected to temper aging in a batch annealing furnace at 450° C. for 2 hours.

Test samples were cut out from the obtained copper alloy sheets (final sheets) and examined by measuring grains and determining or evaluating tensile strength, 0.2% yield strength, electroconductivity, and bending workability by procedures as follows. The results are indicated in Table 2.

Grain Size

The average major axis length and average minor axis length of grains were determined in a plane surface perpendicular to the transverse direction according to a procedure as follows. To observe a microstructure of a sample in a plane perpendicular to the transverse direction, the sample was embedded in a resin, the plane of the sample perpendicular to the transverse direction was sequentially subjected to mechanical polishing, buffing, and electropolishing and yielded a test sample. The test sample was subjected to grain measurement by EBSP using a field emission scanning electron microscope (JEOL JSM 5410 FESEM supplied by JEOL Ltd.). The measurement was performed at arbitrary five points at a position 10 μm deep in the thickness direction from the outermost surface of the test sample, and the measured values were averaged. The measurement was performed in an area (measurement size) of 10 μm in the thickness direction by 30 μm in a direction parallel to the rolling direction.

The EBSP measurement and analysis was performed using EBSP OIM supplied by TexSEM Laboratories, Inc. (TSL Solutions). In the EBSP analysis, each test sample was set in a lens-barrel of the FESEM; electron beams were applied to the test sample; and an electron backscatter diffraction pattern was projected on a screen. An image of this was taken by a highly sensitive camera and captured into a computer. Based on image analysis by the computer, a largest dimension (major axis) and a smallest dimension (minor axis) of each grain were measured, and averages of major axis lengths and of minor axis lengths of all grains in the imaging field of view were calculated. The average lengths are indicated in Table 2.

Tensile Strength and Yield Strength

A test specimen (size: Japanese Industrial Standard (JIS) No. 5) in parallel to the rolling direction was cut out from each sample, and subjected to measurements of tensile strength and 0.2% yield strength with the Universal Testing Machine Model 5882 (INSTRON Co., Ltd.) under conditions of room temperature, a testing speed of 10.0 mm/min, and a gage length (GL) of 50 mm. A sample having a tensile strength 470 MPa or more and a 0.2% yield strength of 450 MPa or more was herein evaluated as having high strengths.

Electroconductivity

The electroconductivity was determined by preparing a strip test specimen having a width of 10 mm and a length of 300 mm by milling, measuring an electric resistance of the test specimen with double-bridge resistance measurement equipment; and calculating the electroconductivity from the electric resistance by the average cross-sectional area method. A sample having an electroconductivity of 70% (IACS) or more was evaluated herein as having good electroconductivity.

Bending Workability

Each copper alloy sheet sample was subjected to a bend test according to Japan Copper and Brass Association Technical Standard. The sheet sample was cut into a test specimen having a width of 10 mm and a length of 30 mm, and the test specimen was subjected to a W-bending test. Specifically, bending was performed so that the ratio R/t of the minimum bend radius R to the copper alloy sheet thickness to be 1.0. While performing W-bending, whether cracking occurred or not in a bent portion was observed with an optical microscope at 10-fold magnification. The cracking was evaluated according to Japan Copper and Brass Association Technical Standard (JBMA-T307: 2007). The cracking is evaluated in five levels in the Japan Copper and Brass Association Technical Standard. However, the cracking was evaluated in the present invention in nine levels so as to evaluate bending workability in detail. Specifically, the maximum width (μm) of “wrinkles” and “cracks” was evaluated as A (10 or less), A-B (from greater than 10 to 15), B (from greater than 15 to 20), B-C (from greater than 20 to 25), C (from greater than 25 to 30), C-D (from greater than 30 to 35), D (from greater than 35 to 40), D-E (from greater than 40 to 45), and E (greater than 45). A sample having an evaluation of higher than Level D (i.e., Level C-D or higher) was evaluated herein as having excellent bending workability (accepted). The results are indicated in Table 2.

TABLE 1

| | Chemical composition (in mass percent) | | | | | | | |
|---|---|---|---|---|---|---|---|---|
| Sample | | | | Fe, Ni, | | Sn, Mg, | Cr/ | Cr/ |
| number | Cr | Ti | Si | Co | Zn | Al | Ti | Si |
| 1 | 0.25 | 0.049 | 0.02 | — | — | — | 5.1 | 12.5 |
| 2 | 0.15 | 0.050 | 0.02 | — | — | — | 3.0 | 7.5 |
| 3 | 0.42 | 0.051 | 0.05 | — | — | — | 8.2 | 8.4 |
| 4 | 0.28 | 0.120 | 0.03 | — | — | — | 2.3 | 9.3 |
| 5 | 0.33 | 0.230 | 0.03 | — | — | — | 1.4 | 11.0 |
| 6 | 0.40 | 0.015 | 0.03 | | | | 26.7 | 13.3 |
| 7 | 0.20 | 0.052 | 0.06 | — | — | — | 3.8 | 3.3 |
| 8 | 0.29 | 0.048 | 0.01 | — | — | — | 6.0 | 29.0 |
| 9 | 0.25 | 0.051 | 0.02 | Fe:0.02 | — | — | 4.9 | 12.5 |
| 10 | 0.25 | 0.053 | 0.02 | Ni:0.02 | — | — | 4.7 | 12.5 |
| 11 | 0.25 | 0.051 | 0.02 | Co:0.02 | — | — | 4.9 | 12.5 |
| 12 | 0.21 | 0.050 | 0.02 | Fe:0.1, Ni:0.1 | — | — | 4.2 | 10.5 |
| 13 | 0.25 | 0.048 | 0.02 | — | 0.05 | — | 5.2 | 12.5 |
| 14 | 0.26 | 0.038 | 0.02 | — | — | Sn:0.25 | 6.8 | 13.0 |
| 15 | 0.30 | 0.051 | 0.02 | — | — | Mg:0.03 | 5.9 | 15.0 |
| 16 | 0.29 | 0.050 | 0.02 | — | — | Al:0.01 | 5.8 | 14.5 |
| 17 | 0.30 | 0.052 | 0.02 | Fe:0.02 | 0.05 | Sn:0.05 | 5.8 | 15.0 |
| 18 | 0.25 | 0.049 | 0.02 | — | — | — | 5.1 | 12.5 |
| 19 | 0.25 | 0.049 | 0.02 | — | — | — | 5.1 | 12.5 |
| 20 | 0.60 | 0.052 | 0.02 | — | — | — | 11.5 | 30.0 |
| 21 | 0.05 | 0.028 | 0.01 | | | | 1.8 | 5.0 |
| 22 | 0.30 | 0.394 | 0.05 | — | — | — | 0.8 | 6.0 |
| 23 | 0.28 | 0.005 | 0.02 | | | | 56.0 | 14.0 |
| 24 | 0.30 | 0.050 | 0.17 | — | — | — | 6.0 | 1.8 |
| 25 | 0.10 | 0.206 | 0.02 | — | — | — | 0.5 | 5.0 |
| 26 | 0.20 | 0.053 | 0.12 | — | — | — | 3.8 | 1.7 |
| 27 | 0.30 | 0.052 | 0.02 | Fe:0.5 | — | — | 5.8 | 15.0 |
| 28 | 0.30 | 0.049 | 0.02 | — | — | Sn:0.5 | 6.1 | 15.0 |
| 29 | 0.28 | 0.068 | 0.02 | — | — | — | 4.1 | 14.0 |
| 30 | 0.28 | 0.068 | 0.02 | — | — | — | 4.1 | 14.0 |
| 31 | 0.25 | 0.049 | 0.02 | — | — | — | 5.1 | 12.5 |

TABLE 2

| | | | | | | Properties of final sheet | | | |
|---|---|---|---|---|---|---|---|---|---|
| | | Hot rolling | Cold rolling | Grain size (average) | | Tensile | Yield | Electro- | W-bending |
| Sample | Cooling after | reduction | reduction | Major axis | Minor axis | strength | strength | conductivity | evaluation |
| number | hot rolling | (%) | (%) | (μm) | (μm) | MPa | MPa | % IACS | R/t = 1.0 |
| 1 | water cooling | 90 | 94 | 4.9 | 0.4 | 528 | 502 | 82.0 | C |
| 2 | water cooling | 90 | 94 | 5.3 | 0.4 | 512 | 492 | 78.8 | C |
| 3 | water cooling | 90 | 94 | 4.2 | 0.4 | 531 | 508 | 81.5 | C |
| 4 | water cooling | 90 | 94 | 4.1 | 0.4 | 551 | 537 | 71.4 | C |
| 5 | water cooling | 90 | 94 | 3.8 | 0.4 | 524 | 508 | 70.2 | C-D |
| 6 | water cooling | 90 | 94 | 4.2 | 0.4 | 483 | 473 | 86.2 | B-C |
| 7 | water cooling | 90 | 94 | 4.3 | 0.4 | 529 | 502 | 74.4 | C |
| 8 | water cooling | 90 | 94 | 4.4 | 0.4 | 506 | 489 | 84.2 | C |
| 9 | water cooling | 90 | 94 | 5.1 | 0.4 | 523 | 498 | 79.5 | C |
| 10 | water cooling | 90 | 94 | 4.8 | 0.4 | 531 | 511 | 81.3 | C |
| 11 | water cooling | 90 | 94 | 4.2 | 0.4 | 536 | 516 | 86.2 | C |
| 12 | water cooling | 90 | 94 | 3.7 | 0.4 | 508 | 482 | 77.3 | B-C |
| 13 | water cooling | 90 | 94 | 5.0 | 0.4 | 522 | 503 | 81.3 | C |
| 14 | water cooling | 90 | 94 | 3.9 | 0.4 | 562 | 543 | 70.6 | C-D |
| 15 | water cooling | 90 | 94 | 4.7 | 0.4 | 536 | 510 | 80.3 | C |
| 16 | water cooling | 90 | 94 | 4.5 | 0.4 | 530 | 508 | 81.7 | C |
| 17 | water cooling | 90 | 94 | 4.1 | 0.4 | 558 | 541 | 78.6 | C-D |
| 18 | water cooling | 75 | 94 | 5.7 | 0.4 | 526 | 496 | 82.2 | C-D |
| 19 | water cooling | 90 | 91 | 5.5 | 0.5 | 517 | 488 | 81.7 | C-D |
| 20 | water cooling | 90 | 94 | 4.8 | 0.4 | 540 | 521 | 72.6 | D |
| 21 | water cooling | 90 | 94 | 5.3 | 0.4 | 442 | 417 | 68.8 | B-C |
| 22 | water cooling | 90 | 94 | 4.3 | 0.4 | 462 | 455 | 32.1 | D |
| 23 | water cooling | 90 | 94 | 5.1 | 0.4 | 451 | 432 | 82.1 | C |
| 24 | water cooling | 90 | 94 | 4.7 | 0.4 | 468 | 449 | 64.1 | C |
| 25 | water cooling | 90 | 94 | 4.2 | 0.4 | 422 | 408 | 36.9 | D |
| 26 | water cooling | 90 | 94 | 5.1 | 0.4 | 457 | 435 | 67.3 | C |
| 27 | water cooling | 90 | 94 | 4.3 | 0.4 | 438 | 421 | 63.6 | C |
| 28 | water cooling | 90 | 94 | 3.7 | 0.4 | 585 | 562 | 57.3 | D |
| 29 | air cooling | 90 | 84 | 6.3 | 0.8 | 503 | 471 | 81.4 | D-E |
| 30 | water cooling | 90 | 84 | 6.8 | 0.8 | 521 | 488 | 78.5 | D-E |
| 31 | water cooling | 63 | 94 | 7.1 | 0.4 | 499 | 488 | 78.7 | D |

Samples Nos. 1 to 19 had chemical compositions and were manufactured under conditions both meeting the conditions as specified in the present invention and each offered strengths (tensile strength and 0.2% yield strength), electric conductivity, and bending workability at sufficient levels.

Samples Nos. 20 to 28 had chemical compositions not meeting the conditions specified in the present invention and failed to have desired properties.

Sample No. 20 had a Cr content higher than the range specified in the present invention. Sample No. 20 failed to have sufficient bending workability because Cr, as contained in an excessively high content, caused grains to coarsen in the major axis direction (to have large major axes).

Sample No. 21 had a Cr content lower than the range specified in the present invention. Sample No. 21, as having an excessively low Cr content, suffered from a large amount of titanium not precipitated but dissolved as a solute and had inferior electroconductivity. In addition, the sample had low strengths lower than the predetermined levels and suffered from poor strengths-bending workability balance, although having good bending workability.

Sample No. 22 had a Ti content higher than, and a Cr/Ti ratio lower than, the ranges specified in the present invention. Sample No. 22 had low strengths and poor bending workability and electroconductivity because the copper alloy contained grains coarsened in the major axis direction (having large major axes) and contained a large amount of solute titanium.

Sample No. 23 had a Ti content lower than, and a Cr/Ti ratio higher than, the ranges specified in the present invention. Sample No. 23 had low strengths, thereby failed to have strengths at predetermined levels although having good bending workability, and offered poor strengths-bending workability balance.

Sample No. 24 had a Si content higher than, and a Cr/Si ratio lower than, the ranges specified in the present invention. Sample No. 24 had poor electroconductivity, had low strengths, thereby failed to have strengths at predetermined levels although having good bending workability, and offered poor strengths-bending workability balance.

Sample No. 25 had a Cr/Ti ratio lower than the range specified in the present invention. Sample No. 25 failed to offer sufficient strengths and had poor electroconductivity and inferior bending workability.

Sample No. 26 had a Si content higher than, and a Cr/Si ratio lower than, the ranges specified in the present invention. Sample No. 26 had low strengths, thereby failed to have strengths at predetermined levels although having good bending workability, and offered poor strengths-bending workability balance. This sample also failed to meet predetermined conditions and thereby had poor electroconductivity.

Sample No. 27 had an Fe content higher than the range specified in the present invention. Sample No. 27 had low strengths, thereby failed to have strengths at predetermined levels although having good bending workability, and offered poor strengths-bending workability balance. The sample also had poor electroconductivity.

Sample No. 28 had a Sn content higher than the range specified in the present invention. Sample No. 28 had poor electroconductivity and inferior bending workability.

Samples Nos. 29 to 31 had chemical compositions meeting the conditions specified in the present invention, but were manufactured under conditions not meeting the conditions specified in the present invention. The samples thereby failed to control the average major axis length of grains within the predetermined range and failed to offer desired properties.

Sample No. 29 underwent air cooling as cooling after hot rolling and underwent cold rolling performed to an excessively low rolling reduction. Sample No. 29 suffered from coarsening of grains in the major axis direction and failed to offer sufficient bending workability because the cooling rate and the rolling reduction did not meet the conditions specified in the present invention.

Sample No. 30 underwent cold rolling performed to an excessively low rolling reduction. Sample No. 30 suffered from coarsening of grains in the major axis direction and had poor bending workability. This is because the cold rolling performed to such a low rolling reduction failed to contribute to grain refinement.

Sample No. 31 underwent hot rolling performed to an excessively low rolling reduction. The sample had poor bending workability because such low rolling reduction impeded the control of grains (in major axis) to a predetermined size.

### Experimental Example 2

### Second Copper Alloys

Material copper alloys were melted with coverage of charcoal in a kryptol furnace in the air, cast into a cast-iron book mold, and yielded ingots of 200 mm thick (Samples Nos. A1 to A23, A27 to A33, and A36) or 100 mm thick (Samples Nos. A24 to A26, A34, A35, and A37). The ingots had chemical compositions given in Table 1 with the remainder including copper and inevitable impurities.

To perform hot rolling to different hot rolling reductions, some of the samples were then faced on surface to 80 mm thick (Sample No. A24) or 50 mm thick (Samples Nos. A25, A26, A34, A35, and A37). Thereafter all the samples were heated, held for one hour after reaching 950° C., hot-rolled to a predetermined rolling reduction as given in “hot rolling reduction” in Table 3, and yielded 20-mm thick sheets (Samples Nos. A1 to A24, A27 to A34, A36, and A37) or 5-mm thick sheets (Samples Nos. A25, A26, and A35). After the completion of rolling, the samples (sheets) were cooled from a temperature of 750° C. or higher down to room temperature by water cooling at an average cooling rate of 100° C./s. After removal of oxidized scale, some of the samples were subjected to facing (Sample No. A26 to 3.3 mm thick, Sample No. A35 to 2 mm thick, and Sample No. A37 to 2.9 mm thick). Then all the samples were subjected to cold rolling. Between one cold rolling and another, the samples were subjected to process annealing at a predetermined temperature (as given in “process annealing temperature” in Table 3) for 2 hours, and cooled down to room temperature by water cooling at an average cooling rate of 100° C./s prior to another cold rolling. The cold rolling was performed multiple times to the predetermined rolling reduction (as given in “cold rolling reduction” in Table 3), and the process annealing (under the same conditions as above) was performed between one cold rolling and another. Finally, copper alloy sheets having a thickness after final cold rolling of 0.20 mm were obtained. The copper alloy sheets were subjected to temper aging in a batch annealing furnace at 450° C. for 2 hours.

Sample No. A26 underwent cold rolling once (to a rolling reduction of 94%) without process annealing. Sample No. A37 simulated the technique disclosed in PTL 4. Specifically, Sample No. A37 was subjected sequentially to first cold rolling to a thickness of 1.27 mm, process annealing, and second cold rolling to a thickness of 0.20 mm.

Test samples (test specimens) were cut out from the obtained copper alloy sheets (final sheets) and subjected to grain measurement and evaluations of tensile strength, 0.2% yield strength, electroconductivity, and bending workability according to procedures as follows. The results are indicated in Table 4.

Grain Size and Aspect Ratio

The grain sizes (average lengths) were determined by the procedure of Experimental Example 1.

The aspect ratio was determined by calculating an aspect ratio (ratio of minor axis to major axis) of each grain from the measured major axis and minor axis of the grain, averaging aspect ratios of the grains, and defining this as an average aspect ratio (indicated as “average aspect ratio” in Table 4).

Tensile Strength and Yield Strength

The tensile strength and 0.2% yield strength were measured and evaluated by the procedure of Experimental Example 1.

Electroconductivity

The electroconductivity was determined by measurement and calculation by the procedure of Experimental Example 1. A sample having an electroconductivity of 70% (IACS) or more was herein evaluated as having good electroconductivity.

Bending Workability

The bending workability was evaluated by the procedure of Experimental Example 1, except for performing bending so that the ratio (R/t) of the bend radius R to the copper alloy sheet thickness to be 0.5. The bending workability was evaluated in nine levels as in Experimental Example 1. In Experimental Example 2, a sample evaluated as higher than Level D (i.e., Level C-D or higher) was evaluated as having excellent bending workability. The results are indicated in Table 4. The bending workability was evaluated in Experimental Example 2 under more severe conditions than those in Experimental Example 1.

### [Table 3]

TABLE 3-1

| | | | | | | | | | Hot | Cold | Process |
|---|---|---|---|---|---|---|---|---|---|---|---|
| | Chemical composition (in mass percent) | | | | | | | | rolling | rolling | annealing |
| Sample | | | | Fe, Ni, | | Sn, Mg, | | | reduction | reduction | temperature |
| number | Cr | Ti | Si | Co | Zn | Al | Cr/Ti | Cr/Si | (%) | (%) | (° C.) |
| A1 | 0.27 | 0.051 | 0.02 | — | — | — | 5.3 | 13.5 | 90 | 99 | 300 |
| A2 | 0.27 | 0.051 | 0.02 | — | — | — | 5.3 | 13.5 | 90 | 99 | 375 |
| A3 | 0.26 | 0.050 | 0.02 | — | — | — | 5.2 | 12.4 | 90 | 99 | 450 |
| A4 | 0.26 | 0.050 | 0.02 | — | — | — | 5.2 | 12.4 | 90 | 99 | 550 |
| A5 | 0.17 | 0.050 | 0.02 | — | — | — | 3.4 | 8.5 | 90 | 99 | 375 |
| A6 | 0.43 | 0.043 | 0.02 | — | — | — | 10.0 | 26.9 | 90 | 99 | 375 |
| A7 | 0.25 | 0.012 | 0.03 | — | — | — | 20.8 | 8.3 | 90 | 99 | 375 |
| A8 | 0.26 | 0.100 | 0.05 | — | — | — | 2.6 | 5.0 | 90 | 99 | 375 |
| A9 | 0.25 | 0.262 | 0.03 | — | — | — | 1.0 | 8.3 | 90 | 99 | 375 |
| A10 | 0.28 | 0.051 | 0.01 | — | — | — | 5.5 | 23.3 | 90 | 99 | 375 |
| A11 | 0.33 | 0.052 | 0.06 | — | — | — | 6.3 | 5.2 | 90 | 99 | 375 |
| A12 | 0.25 | 0.051 | 0.02 | Fe: 0.014 | — | — | 4.9 | 10.9 | 90 | 99 | 375 |
| A13 | 0.25 | 0.053 | 0.02 | Ni: 0.014 | — | — | 4.7 | 12.5 | 90 | 99 | 375 |
| A14 | 0.25 | 0.051 | 0.02 | Co: 0.020 | — | — | 4.9 | 11.4 | 90 | 99 | 375 |
| A15 | 0.26 | 0.050 | 0.02 | Fe: 0.015, | — | — | 5.2 | 12.4 | 90 | 99 | 375 |
| | | | | Ni: 0.014 | | | | | | | |
| A16 | 0.27 | 0.051 | 0.02 | Fe: 0.100, | — | — | 5.3 | 11.7 | 90 | 99 | 375 |
| | | | | Ni: 0.100 | | | | | | | |
| A17 | 0.30 | 0.048 | 0.02 | — | 0.05 | — | 6.3 | 14.3 | 90 | 99 | 375 |
| A18 | 0.28 | 0.049 | 0.02 | Fe: 0.015, | 0.04 | — | 5.7 | 13.3 | 90 | 99 | 375 |
| | | | | Ni: 0.014 | | | | | | | |
| A19 | 0.29 | 0.046 | 0.02 | — | — | Sn: 0.25 | 6.3 | 14.5 | 90 | 99 | 375 |
| A20 | 0.33 | 0.053 | 0.02 | — | — | Mg: 0.03 | 6.2 | 16.5 | 90 | 99 | 375 |
| A21 | 0.33 | 0.044 | 0.02 | — | — | Al: 0.01 | 7.5 | 16.5 | 90 | 99 | 375 |
| A22 | 0.26 | 0.050 | 0.02 | Fe: 0.015, | — | Sn: 0.25 | 5.2 | 12.4 | 90 | 99 | 375 |
| | | | | Ni: 0.014 | | | | | | | |
| A23 | 0.27 | 0.053 | 0.02 | Fe: 0.014, | 0.05 | Sn: 0.05 | 5.1 | 15.0 | 90 | 99 | 375 |
| | | | | Ni: 0.014 | | | | | | | |
| A24 | 0.27 | 0.051 | 0.02 | — | — | — | 5.3 | 13.5 | 75 | 99 | 375 |
| A25 | 0.27 | 0.051 | 0.02 | — | — | — | 5.3 | 13.5 | 90 | 96 | 375 |
| A26 | 0.25 | 0.049 | 0.02 | — | — | — | 5.1 | 12.5 | 90 | 94 | — |
| A27 | 0.61 | 0.052 | 0.02 | — | — | — | 11.7 | 30.5 | 90 | 99 | 375 |
| A28 | 0.05 | 0.054 | 0.01 | — | — | — | 0.9 | 4.2 | 90 | 99 | 375 |
| A29 | 0.27 | 0.005 | 0.02 | — | — | — | 54.0 | 13.5 | 90 | 99 | 375 |
| A30 | 0.27 | 0.394 | 0.05 | — | — | — | 0.7 | 5.2 | 90 | 99 | 375 |

TABLE 3-2

| | | | | | | | | | Hot | Cold | Process |
|---|---|---|---|---|---|---|---|---|---|---|---|
| | Chemical composition (in mass percent) | | | | | | | | rolling | rolling | annealing |
| Sample | | | | Fe, Ni, | | Sn, Mg, | | | reduction | reduction | temperature |
| number | Cr | Ti | Si | Co | Zn | Al | Cr/Ti | Cr/Si | (%) | (%) | (° C.) |
| A31 | 0.30 | 0.051 | 0.17 | — | — | — | 5.9 | 1.7 | 90 | 99 | 375 |
| A32 | 0.30 | 0.052 | 0.02 | Fe: 0.5 | — | — | 5.8 | 14.3 | 90 | 99 | 375 |
| A33 | 0.30 | 0.049 | 0.02 | — | — | Sn: 0.52 | 6.1 | 15.0 | 90 | 99 | 375 |
| A34 | 0.27 | 0.051 | 0.02 | — | — | — | 5.3 | 13.5 | 60 | 99 | 375 |
| A35 | 0.27 | 0.051 | 0.02 | — | — | — | 5.3 | 13.5 | 90 | 90 | 375 |
| A36 | 0.26 | 0.050 | 0.02 | — | — | — | 5.2 | 12.4 | 90 | 99 | 700 |
| A37 | 0.27 | 0.051 | 0.02 | — | — | — | 5.3 | 13.5 | 60 | 93 | 470 |

TABLE 4

| | Final sheet grains | | | Properties of final sheet | | | |
|---|---|---|---|---|---|---|---|
| | Average | Average | Average | Tensile | 0.2% Yield | Electro- | W-bending |
| Sample | aspect | major axis | minor axis | strength | strength | conductivity | evaluation |
| number | ratio | μm | μm | MPa | MPa | % IACS | R/t = 0.5 |
| A1 | 0.127 | 3.6 | 0.29 | 523 | 514 | 82.5 | C |
| A2 | 0.124 | 3.7 | 0.30 | 518 | 501 | 81.6 | D-C |
| A3 | 0.121 | 4.4 | 0.36 | 516 | 487 | 83.4 | C |
| A4 | 0.122 | 3.9 | 0.36 | 492 | 471 | 82.6 | C |
| A5 | 0.121 | 4.3 | 0.34 | 480 | 472 | 83.6 | D-C |
| A6 | 0.201 | 3.6 | 0.26 | 510 | 486 | 83.9 | C-B |
| A7 | 0.123 | 4.3 | 0.35 | 486 | 475 | 84.5 | D-C |
| A8 | 0.198 | 3.5 | 0.23 | 534 | 529 | 72.6 | C-B |
| A9 | 0.242 | 3.3 | 0.21 | 548 | 541 | 70.1 | D-C |
| A10 | 0.126 | 3.7 | 0.30 | 515 | 499 | 83.2 | C |
| A11 | 0.125 | 3.7 | 0.30 | 520 | 513 | 80.9 | C |
| A12 | 0.124 | 3.7 | 0.30 | 520 | 502 | 81.5 | C |
| A13 | 0.124 | 3.7 | 0.30 | 521 | 505 | 81.8 | C |
| A14 | 0.125 | 3.7 | 0.30 | 518 | 502 | 80.8 | D-C |
| A15 | 0.125 | 3.7 | 0.31 | 519 | 503 | 82.2 | C |
| A16 | 0.124 | 3.7 | 0.31 | 521 | 513 | 78.3 | D-C |
| A17 | 0.122 | 3.6 | 0.30 | 516 | 498 | 78.5 | D-C |
| A18 | 0.125 | 3.6 | 0.30 | 519 | 489 | 76.8 | C |
| A19 | 0.124 | 3.7 | 0.30 | 525 | 510 | 78.3 | D-C |
| A20 | 0.125 | 3.7 | 0.30 | 519 | 500 | 80.5 | C |
| A21 | 0.124 | 3.7 | 0.30 | 515 | 496 | 81.7 | C |
| A22 | 0.125 | 3.6 | 0.30 | 527 | 518 | 80.7 | C |
| A23 | 0.127 | 3.5 | 0.30 | 531 | 510 | 79.6 | C |
| A24 | 0.124 | 4.0 | 0.36 | 518 | 501 | 81.6 | D-C |
| A25 | 0.117 | 4.3 | 0.31 | 502 | 488 | 80.1 | D-C |
| A26 | 0.107 | 4.9 | 0.42 | 528 | 502 | 82.0 | D |
| A27 | 0.299 | 3.4 | 0.39 | 531 | 526 | 64.2 | D |
| A28 | 0.113 | 3.6 | 0.23 | 463 | 441 | 68.3 | C-B |
| A29 | 0.121 | 4.4 | 0.37 | 421 | 396 | 85.0 | C |
| A30 | 0.285 | 3.7 | 0.24 | 506 | 482 | 32.1 | D-C |
| A31 | 0.126 | 3.7 | 0.30 | 493 | 481 | 64.1 | D |
| A32 | 0.125 | 3.8 | 0.30 | 504 | 491 | 68.5 | D-C |
| A33 | 0.122 | 3.6 | 0.31 | 515 | 504 | 57.3 | D-C |
| A34 | 0.124 | 5.3 | 0.50 | 514 | 498 | 82.1 | E-D |
| A35 | 0.112 | 4.4 | 0.23 | 489 | 465 | 81.6 | D |
| A36 | 0.305 | 4.4 | 0.43 | 412 | 367 | 88.5 | D-C |
| A37 | 0.111 | 5.4 | 0.61 | 512 | 467 | 83.2 | E-D |

Samples Nos. A1 to A25 had chemical compositions and were manufactured under conditions both meeting the conditions specified in the present invention. The samples each had sufficient electroconductivity and excelled in balance between strengths (tensile strength and 0.2% yield strength) and bending workability.

Samples Nos. A27 to A33 had chemical compositions not meeting the conditions specified in the present invention and failed to offer desired properties.

Sample No. A27 had a Cr content and a Cr/Si ratio both higher than the range specified in the present invention. Sample No. A27, as having the high Cr content, failed to have sufficient bending workability because coarse crystallized grains were formed. The sample, as having the Cr/Si ratio not meeting the predetermined condition, offered poor electroconductivity.

Sample No. A28 had a Cr content and a Cr/Ti ratio both lower than the range specified in the present invention. Sample No. A28, as having the low Cr content, included titanium not precipitated, but dissolved as a solute in a large amount and offered inferior electroconductivity. The sample also had low strengths, thereby failed to have strengths at predetermined levels although having good bending workability, and offered poor strengths-bending workability balance.

Sample No. A29 had a Ti content lower than, and a Cr/Ti ratio higher than, the ranges specified in the present invention. Sample No. A29 had low strengths, thereby failed to have strengths at predetermined levels although having good bending workability, and offered poor strengths-bending workability balance.

Sample No. A30 had a Ti content higher than, and a Cr/Ti ratio lower than, the ranges specified in the present invention. Sample No. 30 contained a large amount of solute titanium and had poor strengths-bending workability balance and inferior electroconductivity.

Sample No. A31 had a Si content higher than, and a Cr/Si ratio lower than, the ranges specified in the present invention. Sample No. A31 had poor electroconductivity, failed to have predetermined bending workability, and offered inferior strengths-bending workability balance.

Sample No. A32 had an Fe content higher than the range specified in the present invention. Sample No. A32 suffered from an excessively large amount of solute iron and had poor electroconductivity.

Sample No. A33 had a Sn content higher than the range specified in the present invention. Sample No. A33 had poor electroconductivity.

Samples Nos. A26 and A34 to A37 were manufactured under conditions not meeting the conditions specified in the present invention and failed to include desired grains.

Sample No. A26 underwent cold rolling performed once to a low rolling reduction without process annealing. Sample No. A26, as undergoing cold rolling to a low rolling reduction without process annealing, failed to have an (average) aspect ratio of grains falling within the predetermined range, had poor balance between major axes and minor axes of grains, and failed to ensure sufficient bending workability.

Sample No. A34 underwent hot rolling performed to a low rolling reduction. Due to the low rolling reduction, the sample failed to have major axes and minor axes of grains controlled within the predetermined sizes and offered poor bending workability.

Sample No. A35 underwent cold rolling performed to a low total rolling reduction. Due to the low rolling reduction, Sample No. A35 failed to have an (average) aspect ratio of grains within the predetermined range, had poor balance between major axes and minor axes of grains, and failed to ensure sufficient bending workability.

Sample No. A36 underwent process annealing performed at a high temperature. Sample No. A36 underwent recrystallization, thereby had remarkably low strengths, and had poor balance between strengths and bending workability although having sufficient bending workability.

Sample No. A37 underwent hot rolling performed to a low rolling reduction and cold rolling performed to a low total rolling reduction. Due to the low rolling reductions, Sample No. A37 included grains being coarsened both in major axis and minor axis, failed to have an aspect ratio controlled within the predetermined range, and failed to ensure sufficient bending workability.

1. A copper alloy comprising copper and:
Cr from 0.10% to 0.50%;
Ti from 0.010% to 0.30%; and
Si from 0.01% to 0.10%,
in mass percent,
wherein:
the mass ratio of the Cr to the Ti is from 1.0 to 30;
the mass ratio of the Cr to the Si is from 3.0 to 30;
and wherein
the copper alloy comprises grains having an average major axis length of 6.0 μm or less and an average minor axis length of 1.0 μm or less as measured on a microstructure of the copper alloy in a plane surface perpendicular to a transverse direction by field emission scanning electron microscopy-electron backscatter diffraction pattern (FESEM-EBSP) analysis.

2. The copper alloy according to claim 1,
wherein:
the grains of the copper alloy have an average major axis length of 5.0 μm or less and an average minor axis length of 0.40 μm or less; and
the grains have an average aspect ratio of from 0.115 to 0.300 where the aspect ratio of a grain is defined as a ratio of a minor axis to a major axis of the grain.

3. The copper alloy according to claim 1, further comprising a positive amount of at least one element selected from the group consisting of:
Fe, Ni, and Co,
wherein the total mass content of said group is 0.3% or less.

4. The copper alloy according to claim 1, further comprising Zn in a positive amount of 0.5% or less (by mass).

5. The copper alloy according to claim 1, further comprising a positive amount of at least one element selected from the group consisting of:
Sn, Mg, and Al,
wherein the total mass of said group is 0.3% or less.

6. The copper alloy according to claim 1, wherein:
the Cr content is from 0.20% to 0.40%;
the Ti content is from 0.020% to 0.15%; and
the Si content is from 0.02% to 0.08%,
in mass percent, wherein:
the mass ratio of the Cr to the Ti is from 3.0 to 15;
the mass ratio of the Cr to the Si is from 10.0 to 20; and wherein
the copper alloy comprises grains having an average major axis length of 6.0 μm or less and an average minor axis length of 1.0 μm or less as measured on a microstructure of the copper alloy in a plane surface perpendicular to a transverse direction by field emission scanning electron microscopy-electron backscatter diffraction pattern (FESEM-EBSP) analysis.

7. The copper alloy according to claim 1, further comprising greater than or equal to 0.03% and less than or equal to 0.2% (by mass) of at least one element selected from the group consisting of Fe, Ni, and Co.

8. The copper alloy according to claim 1, further comprising greater than or equal to 0.03% and less than or equal to 0.3% (by mass) of at least one element selected from the group consisting of Sn, Mg, and Al.

9. The copper alloy according to claim 6, further comprising greater than or equal to 0.03% and less than or equal to 0.2% (by mass) of at least one element selected from the group consisting of Fe, Ni, and Co.

10. The copper alloy according to claim 6, further comprising greater than or equal to 0.03% and less than or equal to 0.3% (by mass) of at least one element selected from the group consisting of Sn, Mg, and Al.
